(19) United States
(12) Patent Application Publication
(10) Pub. No.: US 2007/0224551 A1
(43) Pub. Date: Sep. 27, 2007

(54) METHOD OF FABRICATING PHOTORESIST THINNER

(75) Inventors: Li-Tsang Chou, Taoyuan (TW); Yi-Cheng Chen, Taoyuan (TW)

Correspondence Address: J C PATENTS, INC., 4 VENTURE, SUITE 250, IRVINE, CA, 92618, US

(73) Assignee: QUANTA DISPLAY INC., Taoyuan (TW)

(21) Appl. No.: 11/532,783

(22) Filed: Sep. 18, 2006

(30) Foreign Application Priority Data
Mar. 22, 2006 (TW) 95109792

(51) Int. Cl. G03C 5/00

(52) U.S. Cl. 430/331

(57) ABSTRACT

A method of fabricating photoresist thinner is provided. A photoresist material and a first photoresist thinner are provided. The first photoresist thinner is suitable for thinning the photoresist material. The first photoresist thinner comprises a plurality of first solvents each having a first Hansen parameter. The photoresist material has a second Hansen parameter. A first region is defined according to the first Hansen parameters. A plurality of second solvents is selected according to the first Hansen parameters of the first solvents. Each second solvent has a third Hansen parameters corresponding to at least one of the first solvents. The second solvents are mixed to form a second photoresist thinner. The second photoresist thinner has a fourth Hansen parameter located within the first region. Therefore, the cost of the photoresist thinner can be reduced.

### CROSS-REFERENCE TO RELATED APPLICATION

This application claims the priority benefit of Taiwan application serial no. 95109792, filed on Mar. 22, 2006. All disclosure of the Taiwan application is incorporated herein by reference.

### BACKGROUND OF THE INVENTION

1. Field of the Invention

The present invention relates to a method of fabricating a thinner, and more particularly, to a method of fabricating a photoresist thinner.

2. Description of Related Art

In the current manufacturing process, the color photoresist thinner used for cleaning the color photoresist on a substrate can only be applied to a single specific photoresist. If there is a product change, the color photoresist may have to be changed. Thus, the thinner for cleaning the color photoresist may have to be changed accordingly. In other words, since each specific color photoresist has to correspond to one specific model of thinner, the thinner needs to be changed as the color photoresist is changed. Otherwise, the thinning effect may be compromised and more photoresist residue may be produced, which leads to a drop in the yield of the color filtering plates.

On the other hand, the specific thinner produced by most material manufacturers is generally expensive, mostly poisonous, harmful to human body and also an environment contaminant. As a result, the thinner also incurs many other production costs.

### SUMMARY OF THE INVENTION

Accordingly, at least one objective of the present invention is to provide a method of fabricating photoresist thinner that can disregard the effect of specific photoresist material and concoct the required photoresist thinner on our own so that the cost of the photoresist thinner is reduced.

To achieve these and other advantages and in accordance with the purpose of the invention, as embodied and broadly described herein, the invention provides a method of fabricating photoresist thinner. First, a photoresist material and a first photoresist thinner are provided. The first photoresist thinner is suitable for thinning the photoresist material. The first photoresist thinner comprises a plurality of first solvents each having a first Hansen parameter. The photoresist material has a second Hansen parameter. A first region is defined according to the first Hansen parameters. Then, a plurality of second solvents is selected according to the first Hansen parameters of the first solvents. Each second solvent has a third Hansen parameters corresponding to at least one of the first solvents. Next, the second solvents are mixed to form a second photoresist thinner. The second photoresist thinner has a fourth Hansen parameter on the first region.

According to the foregoing method of fabricating the photoresist thinner in one embodiment of the present invention, the method of mixing the second photoresist solvents includes the following steps. First, the second solvents are mixed using different ratios to obtain a plurality of solution mixtures. Then, the solution mixtures and the photoresist material are mixed using a predetermined ratio. Thereafter, the photoresist material is observed to determine whether the photoresist material dissolves so as to selects a second photoresist thinner from the solution mixtures.

In the method of fabricating the photoresist thinner, according to an embodiment of the present invention, the predetermined ratio is a 3:1 ratio between the solution mixtures and the photoresist material, for example.

In the method of fabricating the photoresist thinner, according to an embodiment of the present invention, one of the criteria for selecting the second solvents includes their physical properties.

In the method of fabricating the photoresist thinner, according to an embodiment of the present invention, the aforementioned physical properties are, for example, surface tension, boiling point or density of the solvents.

In the method of fabricating the photoresist thinner, according to an embodiment of the present invention, the aforementioned second solvents contain a polar-ketone solvent, for example.

In the method of fabricating the photoresist thinner, according to an embodiment of the present invention, the aforementioned second solvents contain a hydrogen-bonding-ketone solvent or a hydrogen-bonding-ether solvent, for example.

In the method of fabricating the photoresist thinner, according to an embodiment of the present invention, the aforementioned second solvents contain a dispersion-alkylbenzene or a dispersion-benzene solvent, for example.

In the method of fabricating the photoresist thinner, according to an embodiment of the present invention, the aforementioned first region is a straight line, for example, and the second Hansen parameter is close to the straight line.

In the method of fabricating the photoresist thinner, according to an embodiment of the present invention, the aforementioned first region is an area region, for example, and the second Hansen parameter is located in the area region.

In the method of fabricating the photoresist thinner, according to an embodiment of the present invention, the aforementioned third Hansen parameters define a second region and the second Hansen parameter is located within the second region.

In the method of fabricating the photoresist thinner, according to an embodiment of the present invention, the aforementioned fourth Hansen parameters are close to the second Hansen parameter.

According to one embodiment of the present invention, a Hansen model is used to select the solvents for thinning the photoresist. This solvents can be used not only for thinning a single type of photoresist material, but can also be used to avoid the high cost and high toxicity resulting from the use a specific thinner.

It is to be understood that both the foregoing general description and the following detailed description are exemplary, and are intended to provide further explanation of the invention, as defined in the appended claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention, where:

FIG. 1 is a flow diagram showing the method of fabricating photoresist thinner according to the embodiment of the present invention.

FIG. 2 is a diagram showing a Hansen model between a solution mixture of ethanol and toluene and tetrahydrofuran.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

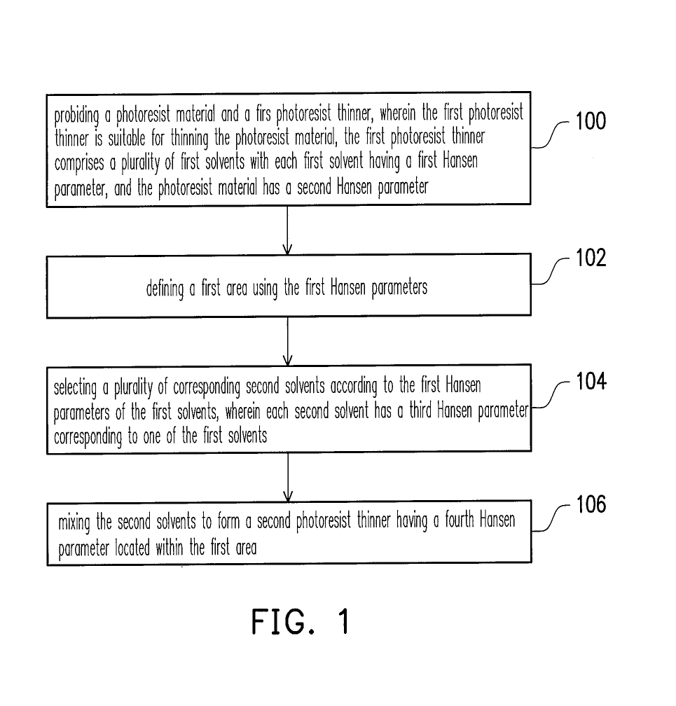

FIG. 1 is a flow diagram showing a method of fabricating photoresist thinner according to the embodiment of the present invention. First, in step 100, a photoresist material and a first photoresist thinner are provided. The first photoresist thinner is suitable for thinning the photoresist material. In the present embodiment, the first photoresist thinner is the specific thinner, provided by the photoresist material manufacturer, corresponding to this particular type of photoresist material. The first photoresist thinner includes a plurality of first solvents. Furthermore, each of the first solvents has a first Hansen parameter according to the Hansen model. The photoresist material also has a second Hansen parameter according to the Hansen model. It is noted that the Hansen parameters represent the coordinate position (δ_{d}, δₚ, δₕ) in the Hansen model. Herein, δ_{d} represents the dispersion component, δₚ represents the polar component and δₕ represent the hydrogen-bonding component.

Then, in step 102, a first region is defined according to the first Hansen parameters. In one embodiment, when the first photoresist thinner comprises only two types of first solvents, the first region, which is defined by the first Hansen parameters of the first solvents, is a straight line, and the straight line is close to the second Hansen parameter of the photoresist material. In another embodiment, when the first photoresist thinner comprises more than two types of first solvents, the first region defined by the first Hansen parameters of the first solvents is an area region and encircles the second Hansen parameter of the photoresist material.

Thereafter, in step 104, a plurality of corresponding second solvents is selected according to the first Hansen parameters of the first solvents. Each second solvent has a third Hansen parameter that corresponds to one of the first solvent. It is noted that these third Hansen parameters define a second region and the second Hansen parameter is located within the second region.

In general, the criteria for selecting the second solvents may include a reference to their physical properties such as surface tension, boiling point or density. Alternatively, the criteria for selecting the second solvents may include a reference to the first solvents of the first photoresist thinner. For example, the second solvents may contain a polar-ketone solvent, or a hydrogen-bonding-ketone solvent, or an ether solvent, or a dispersion-alkylbenzene or benzene solvent.

After that, in step 106, the second solvents are mixed to form a second photoresist thinner. The second photoresist thinner has a fourth Hansen parameter located within the first region. More specifically, these second solvents are mixed in different ratios to obtain a plurality of solution mixtures. Each solution mixture has a fourth Hansen parameter according to the Hansen model. The fourth Hansen parameters are controlled within the first region defined by the first Hansen parameters. In other words, the fourth Hansen parameters are located in the aforementioned region (as described in Table 3 and Table 4) or near the straight line (as described in Table 1) close to the second Hansen parameter.

For example, each of the solution mixtures and the photoresist material are mixed in a predetermined ratio such as 3:1. Then, the photoresist material is observed to determine whether the photoresist material dissolves so that at least one of the solution mixtures can be selected to serve as the second photoresist thinner for cleaning the photoresist material.

In the following, three groups of experiments are described to explain the present invention in detail. Because the common photoresist thinner such as tetrahydrofuran (THF) is relatively toxic and expensive to produce, the present embodiment uses a solution mixture of ethanol and toluene as a substitute, wherein the ratio of ethanol to toluene is 50:50. In other words, the ethanol and toluene solution mixture is the aforementioned second solvent. Table 1 lists the ratios between the dispersion δ_{d}, the polarity δₚ and the hydrogen bonding δₕ of the Hansen parameters for the ethanol and toluene solution mixture and the tetrahydrofuran. Table 2 is a Hansen model of the ethanol and toluene solution mixture and the tetrahydrofuran.

TABLE 1

| | f_{d} | fₚ | fₕ |
|---|---|---|---|
| Ethanol and | 60 | 13 | 27 |
| Toluene 50:50 | | | |
| Tetrahydrofuran | 55 | 19 | 26 |

According to Table 1 and Table 2, a 50:50 solution mixture of ethanol and toluene can replace the commonly used tetrahydrofuran in order to save cost and increase safety. Furthermore, the parameters f_{d}, fₚ and fₕ in Table 1 are the normalized Hansen parameters. More specifically, the Hansen parameters for the ethanol and the toluene are (δ_{d}: 15.8 Mpa^{1/2}, δₚ: 8.8 Mpa^{1/2}, δₕ: 19.4 Mpa^{1/2}) and (δ_{d}: 16.8 Mpa^{1/2}, δₚ: 5.7 Mpa^{1/2}, δₕ: 8.0 Mpa^{1/2}) respectively. The connecting line between the Hansen parameters of the ethanol and the toluene passes close to the Hansen parameter of the tetrahydrofuran. Therefore, the Hansen parameter of the ethanol and toluene solution mixture can be adjusted to a value close to the Hansen parameter of the tetrahydrofuran.

When the ethanol and the toluene are mixed together in a 50:50 ratio to form a solution mixture, the Hansen parameter of the solution mixture is (δ_{d}: 17.9 Mpa^{1/2}, δₚ: 5.8 Mpa^{1/2}, δₕ: 7.6 Mpa^{1/2}). Thus, the Hansen parameter of this ethanol/toluene solution mixture is very close to the Hansen parameter of tetrahydrofuran. In other words, ethanol/toluene solution mixture can serve as a substitute for tetrahydrofuran.

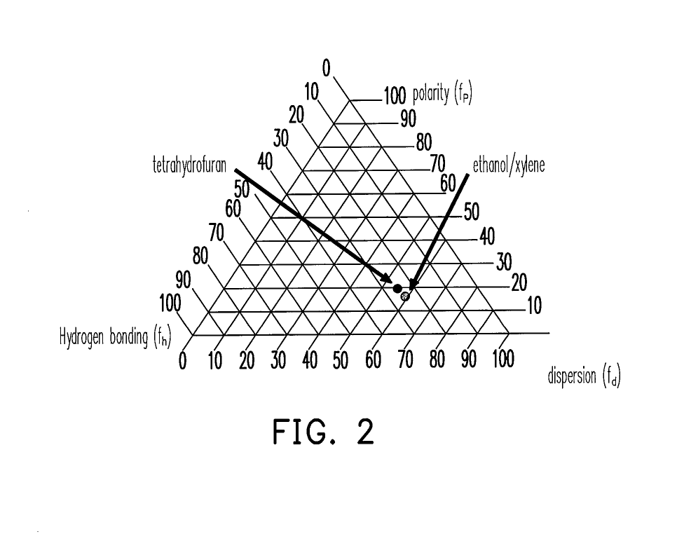

In another embodiment, a ToyoInk series of photoresist material having Hansen parameters (δ_{d}: 17.9 Mpa^{1/2}, δₚ: 5.8 Mpa^{1/2}, δₕ: 7.6 Mpa^{1/2}) is provided. Its main solvents include cyclohexanone having Hansen parameters (δ_{d}: 17.8 Mpa^{1/2}, δₚ: 6.3 Mpa^{1/2}, δₕ: 5.1 Mpa^{1/2}) with propylene glycol methylether acetate (PGMEA) and xylene selected as the ingredients of the second solvents. The Hansen parameters for the PGMEA and the xylene are (δ_{d}: 15.6 Mpa^{1/2}, δₚ: 5.6 Mpa^{1/2}, δₕ: 9.8 Mpa^{1/2}) and (δ_{d}: 17.6 Mpa^{1/2}, δₚ: 1 Mpa^{1/2}, δₕ: 3.1 Mpa^{1/2}) respectively. In other words, the cyclohexanone, the PGMEA and the xylene are close to the three corners of the triangle shown in FIG. 2. That means, the Hansen parameters of the photoresist material in the ToyoInk series are located within the region enclosed by the Hansen parameters of the cyclohexanone, the PGMEA and the xylene.

After mixing the cyclohexanone, the PGMEA and the xylene together in different percentage by weight to form a number of solution mixtures and then mixing each solution mixture with photoresist material in a 3:1 ratio (300 cc: 100 cc) at a temperature of about 25° C., each of the mixtures is observed to determine if there is any photoresist settling out as precipitation so that a photoresist thinner capable of dissolving the ToyoInk series of photoresist material is selected. Table 2 lists various photoresist materials and their associated thinners. Table 3 lists the results after mixing the photoresist materials with various types of solution mixtures. The squares marked with an ‘O’ indicate no precipitation and those squares marked with an ‘X’ indicate some precipitation.

TABLE 2

| | |
|---|---|
| Photoresist Material 1 | TOK |
| | 500BL (cyclohexanone + propylene glycol |
| | methylether acetate (PGMEA) + |
| | 5-methylbenzimidazole (MBA)) |
| Photoresist Material 2 | FFA CKB045 (cyclohexanone + DEDG) |
| Photoresist Material 3 | NSBK3020 (cyclohexanone + propylene glycol |
| | methylether acetate (PGMEA)) |
| Photoresist Material 4 | ADK L432-MSL-200 |
| Photoresist Material 5 | ToyoInk RS 2050 (cyclohexanone) |
| Photoresist Material 6 | ToyoInk GS 2050 (cyclohexanone) |
| Photoresist Material 7 | ToyoInk BS 2050 (cyclohexanone) |

TABLE 3

| Cyclohexanone/ | | | | | | | |
|---|---|---|---|---|---|---|---|
| propylene | | | | | | | |
| glycol | | | | | | | |
| methylether | | | | | | | |
| acetate/Xylene | | | | | | | |
| (Weight | Photoresist | Photoresist | Photoresist | Photoresist | Photoresist | Photoresist | Photoresist |
| Ratio) | material 1 | material 2 | material 3 | material 4 | material 5 | material 6 | material 7 |
| 20/70/10 | X | X | X | X | X | X | X |
| 30/60/10 | X | X | X | X | X | X | X |
| 40/50/10 | X | X | X | ◯ | ◯ | ◯ | ◯ |
| 40/40/20 | X | X | X | X | X | X | X |
| 45/45/10 | X | X | X | ◯ | ◯ | ◯ | ◯ |
| 50/40/10 | X | X | X | X | X | X | X |
| 60/30/10 | X | X | X | X | X | X | X |
| 70/20/10 | X | X | X | X | X | X | X |

According to Table 2 and Table 3, when the weight ratios of the cyclohexanone/propylene glycol methylether acetate/xylene solution mixture are 40/50/10 and 45/45/10, the photoresist material in the ToyoInk series and the photoresist material 4 are simultaneously dissolved. Therefore, when the weight ratios of a cyclohexanone/propylene glycol methylether acetate/xylene solution mixture are 40/50/10 and 45/45/10, the solution mixtures can replace the specific photoresist thinner of the ToyoInk series and the specific thinner for the photoresist material 4. In addition, the present embodiment selects propylene glycol methylether acetate and xylene as the ingredients of the photoresist thinner. However, the present embodiment also permits the selection of other solution according to the Hansen model whose detail is described below.

In another embodiment, a ToyoInk series of photoresist material having Hansen parameters (δ_{d}: 17.9 Mpa^{1/2}, δₚ: 5.8 Mpa^{1/2}, δₕ: 7.6 Mpa^{1/2}) is provided. Its main solvents include cyclohexanone having Hansen parameters (δ_{d}: 17.8 Mpa^{1/2}, δₚ: 6.3 Mpa^{1/2}, δₕ: 5.1 Mpa^{1/2}) with cyclohexanone, propylene glycol methylether acetate (PGMEA) and alkylbenzene selected as the ingredients of the second solvents. The Hansen parameters for alkylbenzene is (δ_{d}: 17.6 Mpa^{1/2}, δₚ: 0.81 Mpa^{1/2}, δₕ: 0 Mpa^{1/2}). In other words, the cyclohexanone, the PGMEA and the alkylbenzene are close to the three peak points of the triangle shown in FIG. 2. Similarly, the Hansen parameters of the photoresist material in the ToyoInk series are located within the region enclosed by the Hansen parameters of the cyclohexanone, the PGMEA and the alkylbenzene.

After mixing each solution mixture with the photoresist material in a 3:1 ratio (300 cc: 100 cc) at a temperature of about 25° C., each of the mixtures is observed to determine if there is any photoresist settling out as precipitation so that a photoresist thinner capable of dissolving the photoresist material in the ToyoInk series is selected. Table 4 lists the results after mixing the photoresist materials with various types of solution mixtures. The squares marked with an ‘O’ indicate no precipitation and those squares marked with an ‘X’ indicate some precipitation.

TABLE 4

| Cyclohexanone/ | | | | | | | |
|---|---|---|---|---|---|---|---|
| propylene | | | | | | | |
| glycol | | | | | | | |
| methylether | | | | | | | |
| acetate/Arylbenzene | | | | | | | |
| (Weight | Photoresist | Photoresist | Photoresist | Photoresist | Photoresist | Photoresist | Photoresist |
| Ratio) | material 1 | material 2 | material 3 | material 4 | material 5 | material 6 | material 7 |
| 20/70/10 | X | X | X | ◯ | ◯ | ◯ | ◯ |
| 30/60/10 | X | X | X | ◯ | ◯ | ◯ | ◯ |
| 40/50/10 | X | X | X | X | X | X | X |
| 40/40/20 | X | X | X | ◯ | ◯ | ◯ | ◯ |
| 45/45/10 | X | X | X | ◯ | ◯ | ◯ | ◯ |
| 50/40/10 | X | X | X | X | X | X | X |
| 60/30/10 | X | X | X | X | X | X | X |
| 70/20/10 | X | X | X | X | X | X | X |

As shown in Table 4, when the weight ratios of the cyclohexanone/propylene glycol methylether acetate/arylbenzene solution mixture are 20/70/10, 30/60/10, 40/40/20 and 45/45/10, the photoresist material in the ToyoInk series and the photoresist material 4 are simultaneously dissolved. Therefore, the aforementioned weight ratios can replace the specific photoresist thinner of the ToyoInk series and the specific thinner for the photoresist material 4.

In summary, the present invention utilizes the Hansen model to select a plurality of solvents for producing a solution mixture. By adjusting the weight ratios of various solvents in the solution mixture, cheaper, relatively non-toxic and environmentally friendly photoresist thinners are rapidly selected. Moreover, a photoresist thinner capable of dissolving more than one type of photoresist materials can be found. As a result, the need to use a corresponding type of photoresist thinner for each photoresist material is avoided so that the production cost can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of fabricating photoresist thinner, comprising:
providing a photoresist material and a first photoresist thinner, wherein the first photoresist thinner comprises a plurality of first solvents, and each of the first solvents has a first Hansen parameter and the photoresist material has a second Hansen parameter;
defining a first region using the first Hansen parameters;
selecting a plurality of corresponding second solvents according to the first Hansen parameters of the first solvents, wherein each of the second solvents has a third Hansen parameter that corresponds to one of the first solvents; and
mixing the second solvents to form a second photoresist thinner having a fourth Hansen parameter located within the first region.

2. The method of claim 1, wherein mixing the second solvents to form the second photoresist thinner comprises:
mixing the second solvents in different ratios to obtain a plurality of solution mixtures;
mixing each of the solution mixtures and the photoresist material in a predetermined ratio; and
observing the photoresist material to determine whether the photoresist material dissolves so as to select the second photoresist thinner from the solution mixtures.

3. The method of claim 2, wherein the predetermined ratio of mixing the solution mixture to the photoresist material is 3:1.

4. The method of claim 1, wherein selecting the second solvents comprises referring to the physical properties of the solvent.

5. The method of claim 4, wherein the physical properties include surface tension, boiling point, and density of the solvent.

6. The method of claim 1, wherein the second solvents comprise a polar-ketone solvent.

7. The method of claim 1, wherein the second solvents comprise a hydrogen-bonding-ketone solvent and a hydrogen-bonding-ether solvent.

8. The method of claim 1, wherein the second solvents comprise a dispersion-alkylbenzene solvent and a dispersion-benzene solvent.

9. The method of claim 1, wherein the first region is a straight line and the second Hansen parameter is close to the straight line.

10. The method of claim 1, wherein the first region is an area region and the second Hansen parameter is located in the area region.

11. The method of claim 1, wherein the third Hansen parameters define a second region and the second Hansen parameter is located within the second region.

12. The method of claim 1, wherein the fourth Hansen parameters are close to the second Hansen parameter.
